(19) United States
(12) Patent Application Publication
(10) Pub. No.: US 2017/0242375 A1
(43) Pub. Date: Aug. 24, 2017

(54) TRANSPARENT ROLL, LIGHT IRRADIATING DEVICE, AND IMAGE FORMING APPARATUS

(71) Applicant: FUJI XEROX CO., LTD., Tokyo (JP)

(72) Inventors: Tomoko MIYAHARA, Kanagawa (JP); Takashi MATSUBARA, Kanagawa (JP); Tetsuro KODERA, Kanagawa (JP)

(73) Assignee: FUJI XEROX CO., LTD., Tokyo (JP)

(21) Appl. No.: 15/205,862

(22) Filed: Jul. 8, 2016

(30) Foreign Application Priority Data
Feb. 24, 2016 (JP) 2016-033552
Feb. 24, 2016 (JP) 2016-033553

(51) Int. Cl. G03G 15/20

(52) U.S. Cl. CPC G03G 15/2007

(57) ABSTRACT

Provided is a transparent roll around which a transparent belt that transmits light from a light source is wound and which presses the transparent belt in a nip portion and transmits the light from the light source, the transparent roll including a base layer, and an elastic layer that is exposed on a transparent belt side with respect to the base layer and is elastically deformed greater than the base layer in the nip portion.

### CROSS-REFERENCE TO RELATED APPLICATIONS

This application is based on and claims priority under 35 USC 119 from Japanese Patent Application Nos. 2016-033552 filed on Feb. 24, 2016 and 2016-033553 filed Feb. 24, 2016.

### BACKGROUND

### Technical Field

The invention relates to a transparent roll, a light irradiating device, and an image forming apparatus.

### SUMMARY

According to an aspect of the invention, there is provided a transparent roll around which a transparent belt that transmits light from a light source is wound and which presses the transparent belt in a nip portion and transmits the light from the light source,

the transparent roll including:

a base layer; and

an elastic layer that is exposed on a transparent belt side with respect to the base layer and is elastically deformed greater than the base layer in the nip portion.

### BRIEF DESCRIPTION OF THE DRAWINGS

Exemplary embodiments of the present invention will be described in detail based on the following figures, wherein:

FIG. 1 is a view of an overall configuration schematically illustrating an image forming apparatus according to a first exemplary embodiment;

FIG. 2 is a view of a configuration schematically illustrating a fixing device according to the first exemplary embodiment;

FIG. 3A is a vertical sectional view illustrating a layer structure of a transparent roll according to the first exemplary embodiment;

FIG. 3B is a vertical sectional view illustrating a layer structure of a transparent belt according to the first exemplary embodiment;

FIG. 4 is an explanatory view schematically illustrating a state where light is applied to a nip portion of the fixing device according to the first exemplary embodiment;

FIG. 5 is an explanatory view schematically illustrating a state where light is applied to a nip portion of a fixing device according to a second exemplary embodiment; and

FIG. 6 is an explanatory view schematically illustrating a state where light is applied to a nip portion of a fixing device according to a comparative example.

### DETAILED DESCRIPTION

### First Exemplary Embodiment

An example of a transparent roll, a light irradiating device, a fixing device, and an image forming apparatus according to a first exemplary embodiment will be described.

Overall Configuration

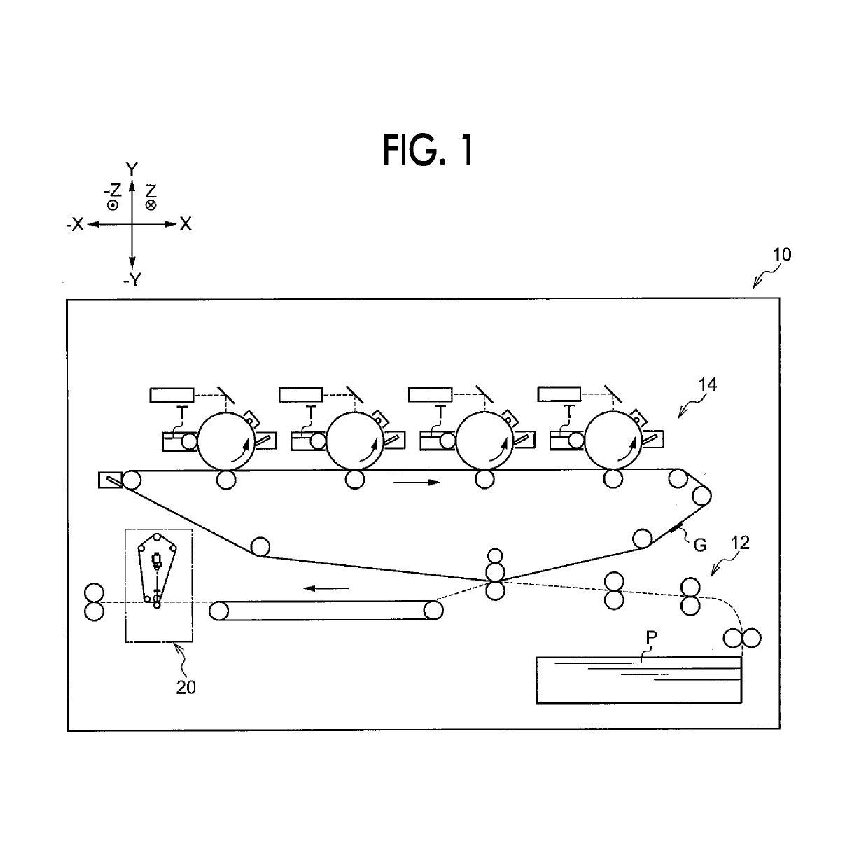

An image forming apparatus 10 of the first exemplary embodiment is illustrated in FIG. 1. The image forming apparatus 10 has, as one example, a transporting portion 12 that transports a sheet P, an image forming portion 14 that forms a toner image G on the transporting sheet P by using toner T, and a fixing device 20 that fixes the toner image G formed by the image forming portion 14 onto the sheet P. The sheet P is one example of a recording medium. The toner T is one example of a developer. The toner image G is one example of a developer image and a light irradiating target. The image forming portion 14 is one example of a developer image forming unit. Furthermore, the image forming portion 14 performs each step of charging, exposing, developing, transferring, and cleaning. In addition, the fixing device 20 is one example of a light irradiating device.

Moreover, in the following description, a direction indicated by an arrow Y in FIG. 1 is a height direction of the image forming apparatus 10 and a direction indicated by an arrow X in FIG. 1 is a width direction. In addition, a direction (indicated by Z) orthogonal to each of the height direction and the width direction is a depth direction. Then, the width direction, the height direction, and the depth direction are respectively described as an X direction, a Y direction, and a Z direction when the image forming apparatus 10 is viewed (front view) from a side on which a user (not illustrated) stands. Furthermore, in a case where it is necessary to distinguish one side and the other side of each of the X direction, the Y direction, and the Z direction, when the image forming apparatus 10 is viewed from the front, an upper side is referred to as a Y side, a lower side is referred to as a −Y side, a right side is referred to as an X side, a left side is referred to as a −X side, a rear side is referred to as a Z side, and a front side is referred to as a −Z side.

Main Configuration

Next, the fixing device 20 will be described.

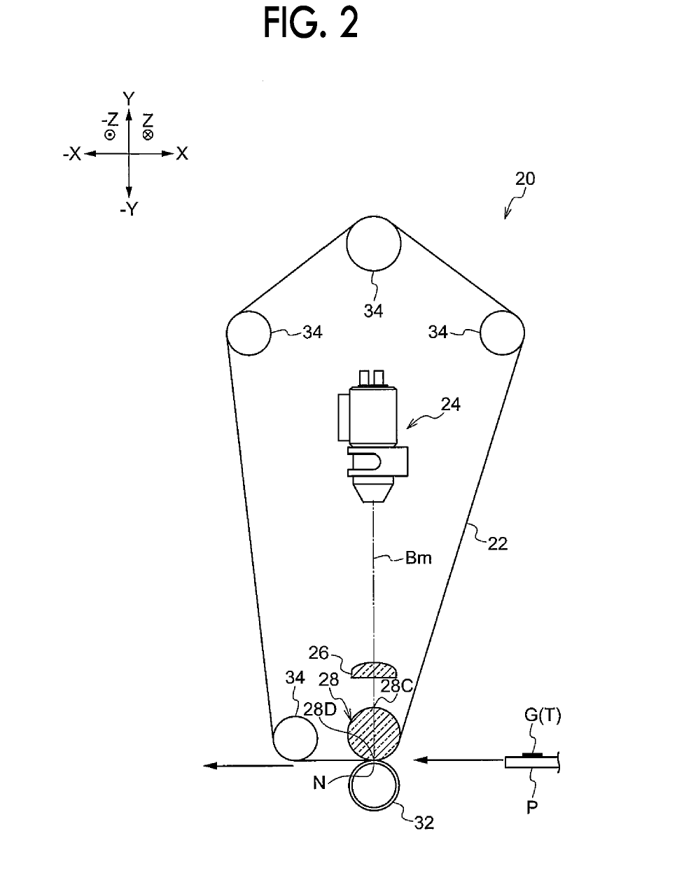

As illustrated in FIG. 2, the fixing device 20 has a transparent belt 22, a light source 24, a condensing lens 26, a transparent roll 28, a pressure roll 32, and belt support rolls 34. The pressure roll 32 is one example of a pressure member.

Light Source

The light source 24 includes, as one example, plural laser arrays (not illustrated) that are arranged in the Z direction and emit a laser beam Bm toward the Y side and a collimating lens (not illustrated) that causes the laser beam Bm emitted from the laser arrays to be parallel light. In addition, the light source 24 is disposed on an inside of the transparent belt 22 and causes the laser beam Bm to be incident on the condensing lens 26 which will be described later. Then, the light source 24 irradiates the toner image G with the laser beam Bm through the condensing lens 26, the transparent roll 28, and the transparent belt 22. The laser beam Bm is one example of the light.

Moreover, in the exemplary embodiment, as one example, a longitudinal direction of the light source 24 is the Z direction, a direction on which the laser beam Bm is applied to the toner image G is the Y direction, and a direction which is orthogonal to the Z direction and the Y direction, and on which the sheet P is transported is the X direction. The sheet P is transported, as one example, from the X side to the −X side.

Condensing Lens

The condensing lens 26 is disposed on an optical axis of the laser beam Bm between the light source 24 and the transparent roll 28. In addition, the condensing lens 26 is a plano-convex lens condensing the laser beam Bm irradiated from the light source 24 on a nip portion N which will be described below.

Transparent Roll

The transparent roll 28, of which an axial direction is the Z direction, is rotatably provided on the inside of the transparent belt 22 and on the Y side of a transport path in which the sheet P is transported. In addition, the transparent belt 22 is wound around the transparent roll 28 (being in contact with the transparent belt 22) and the transparent roll 28 presses the transparent belt 22 with the pressure roll 32 in the nip portion N which will be described below. Furthermore, the transparent roll 28 is an optical member that transmits the laser beam Bm and condenses the laser beam Bm toward the nip portion N which will be described below. The optical axis of the laser beam Bm passes through the center of the transparent roll 28 when the transparent roll 28 is viewed in the Z direction. Moreover, in FIG. 2, the laser beam Bm is indicated by a one-dotted chain line for simplification.

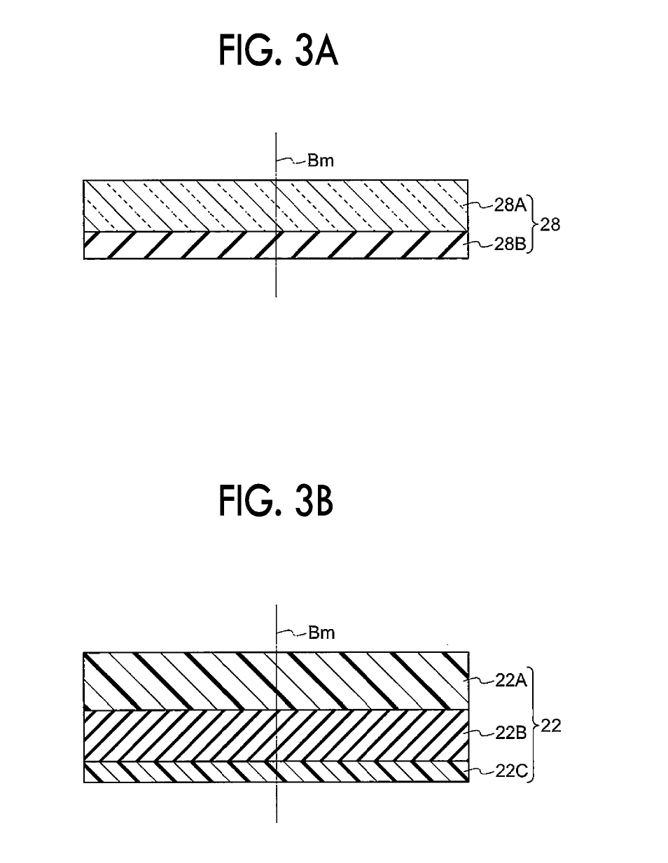

As illustrated in FIG. 3A, the transparent roll 28 has a base layer 28A and an elastic layer 28B. Moreover, in FIG. 3A, the base layer 28A and the elastic layer 28B are illustrated in the plate shape.

Base Layer

The base layer 28A is configured with, as one example, a glass roll that is a cylindrical (solid) rod lens.

Elastic Layer

The elastic layer 28B is exposed on the transparent belt 22 side (outside) of the transparent roll 28 with respect to the base layer 28A. In addition, the elastic layer 28B is configured with, as one example, silicone rubber and transmits the laser beam Bm. Furthermore, the elastic layer 28B is elastically deformed greater than the base layer 28A by winding the transparent belt 22 around the transparent roll 28. Moreover, in the exemplary embodiment, the “elastic layer” is a layer that is elastically deformed greater than the base layer 28A in the thickness direction when being pressed in the nip portion N (see FIG. 2). Moreover, other materials in addition to the silicone rubber, for example, may be chloroprene rubber, butyl rubber, acrylic rubber, urethane rubber, nitrile rubber, fluororubber, styrene-butadiene rubber, and the like.

As illustrated in FIG. 2, a portion where the laser beam Bm is incident on an outer circumferential surface of the transparent roll 28 is referred to as an incident portion 28C. The incident portion 28C is a range (portion) including a top portion of the transparent roll 28 in the Y direction when the transparent roll 28 is viewed in the Z direction. On the other hand, a portion shifted from the incident portion 28C by 180 degrees on the outer circumferential surface of the transparent roll 28 is referred to as a pressure portion 28D. The pressure portion 28D is a portion in which the outer circumferential surface of the transparent roll 28 comes into contact with an inner circumferential surface of the transparent belt 22.

Moreover, in the exemplary embodiment, “transparent” in the transparent belt 22 and the transparent roll 28 means that transparency is sufficiently high in a wavelength range of the laser beam Bm. That is, the transparent belt 22 and the transparent roll 28 may transmit the laser beam Bm, and the higher the transparency is, the better the light utilization efficiency is. The transparency may be, as one example, equal to or greater than 90% and may be preferably equal to or greater than 95%.

Pressure Roll

The pressure roll 32 is formed of, as one example, a cylindrical shape, which is made of stainless steel, and has a shaft portion (not illustrated). In addition, the pressure roll 32, of which an axial direction is the Z direction, is rotatably provided on the −Y side of the transport path in which the sheet P is transported. Furthermore, the pressure roll 32 is disposed so that a predetermined pressurizing force acts between the pressure roll 32 and the transparent belt 22. In other words, the pressure roll 32 sandwiches the sheet P on which the toner image G is formed and the transparent belt 22 together with the transparent roll 28, presses the sheet P and the transparent belt 22, and transports the sheet P and the transparent belt 22 on the −X side.

Here, the transparent belt 22 and the sheet P are sandwiched between the transparent roll 28 and the pressure roll 32, and a portion (region) in which the toner image G is pressed is referred to as the nip portion N. That is, the pressure roll 32 presses the toner image G on the sheet P and the transparent belt 22 toward the transparent roll 28 and forms the nip portion N. In addition, the nip portion N is a portion in which the toner image G (toner T) on the sheet P is heated by the laser beam Bm.

Transparent Belt

The transparent belt 22 is formed in an endless type. In addition, the transparent belt 22 is provided, as one example, so as to be circularly moved by being wound around four belt support rolls 34 and the transparent roll 28 of which axial directions are the Z direction. Then, the belt support roll 34 is driven by gears and a motor (not illustrated) to be rotated and thereby the transparent belt 22 is circularly moved. The laser beam Bm transmits the nip portion N that is pressed by the pressure roll 32 in the transparent belt 22. Furthermore, the transparent belt 22 comes into contact with the toner image G (toner T) on the sheet P in the nip portion N. That is, the toner image G is pressed while being heated by the laser beam Bm in the nip portion N and is fixed onto the sheet P.

As illustrated in FIG. 3B, the transparent belt 22 has a three-layer structure having, as one example, a base material layer 22A, an intermediate layer 22B that is laminated on the base material layer 22A, and a release layer 22C that is laminated on the intermediate layer 22B. Moreover, a primer layer (not illustrated) is formed between the base material layer 22A, the intermediate layer 22B, and the release layer 22C to enhance adhesion.

Base Material Layer

The base material layer 22A is a layer for maintaining a required strength as the transparent belt 22. In addition, the base material layer 22A is configured with, as one example, polyimide and transmits the laser beam Bm. Moreover, other materials which may be used in addition to polyimide, may be polyvinylidene fluoride (PVDF), polyethylene (PE), polyurethane (PU), and polydimethylsiloxane (PDMS). In addition, other materials, which may be used in addition to polyimide, may be polyetheretherketone (PEEK), polyether sulfone (PES), fluorinated ethylene propylene (FEP), and ethylene tetrafluoroethylene copolymer (ETFE). Furthermore, other materials, which may be used in addition to polyimide, may be chlorotrifluoroethylene (CTFE), polyvinylidene fluoride (PVDF), polyvinyl fluoride (PVF), and polytetrafluoroethylene (PTFE). Moreover, the base material layer 22A may be configured with a combination of the materials described above.

Intermediate Layer

The intermediate layer 22B is configured with, as one example, silicone rubber and transmits the laser beam Bm. A material configuring the intermediate layer 22B may be, for example, LSR silicone rubber, HTV silicone rubber, RTV silicone rubber, and the like.

Release Layer

The release layer 22C is configured with, as one example, tetrafluoroethylene perfluoroalkoxy ethylene copolymer (PFA) and transmits the laser beam Bm. In addition, the release layer 22C suppresses adhesion of the toner image G (see FIG. 2) to the transparent belt 22, as compared to a configuration in which the release layer 22C is absent. Other materials configuring the release layer 22C may be, for example, tetrafluoroethylene polymer (PTFE), tetrafluoroethylene hexafluoropropylene copolymer (FEP), ethylene tetrafluoroethylene copolymer (ETFE), and the like. Moreover, the release layer 22C also has a function of applying favorable gloss to the toner image G after the toner image G is fixed in cooperation with the intermediate layer 22B.

### COMPARATIVE EXAMPLE

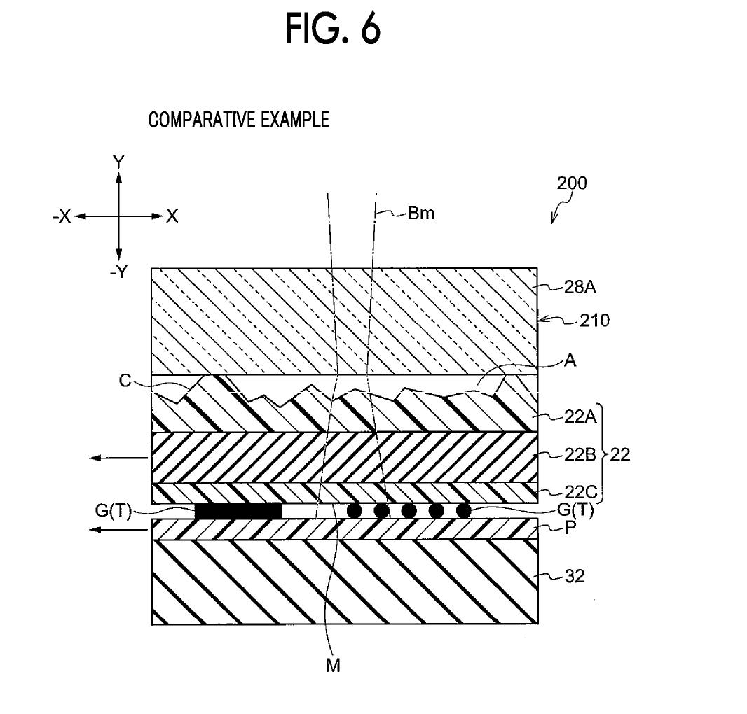

A nip portion M of a fixing device 200 of a comparative example is illustrated in FIG. 6. A transparent roll 210 is provided in the fixing device 200 in place of the transparent roll 28 (see FIG. 2) in the fixing device 20 (see FIG. 2) of the exemplary embodiment and other configurations are similar to those of the fixing device 20. The transparent roll 210 has a single-layer structure only having the base layer 28A. That is, in the transparent roll 210, an elastic layer is not exposed on a transparent belt 22 side. Moreover, a nip portion between the transparent belt 22 and the pressure roll 32 in the fixing device 200 is referred to as the nip portion M.

In the fixing device 200 of the comparative example, when the transparent belt 22 is circularly moved, scratch C may occur on a surface (inner circumferential surface of the transparent belt 22) of the base material layer 22A by wear due to contact between the belt support roll 34 and the base material layer 22A, and between the transparent roll 210 and the base material layer 22A. In this case, roughness of the surface of the base material layer 22A is larger than roughness of the surface of the transparent roll 210. Therefore, many air layers A (gaps) are present between the surface of the base material layer 22A in which the scratch C occurs and the surface of the transparent roll 28.

Here, a refractive index of air is approximately 1.0 (see JIS B 7071-1) while a refractive index of the transparent roll 210 is approximately 1.5 (JIS B 7071-1) and a refractive index of the base material layer 22A is approximately 1.7 (JIS K 7142). That is, in the fixing device 200 of the comparative example, since a difference in the refractive index between the transparent roll 210 and the air layer A is greater than a difference in the refractive index between the transparent roll 210 and the base material layer 22A, the laser beam Bm transmitting the transparent roll 210 is likely to be scattered when the laser beam Bm is incident on the air layer A. In other words, in the fixing device 200 of the comparative example, condensing performance of the laser beam Bm to the nip portion M is decreased.

Operation

Next, an operation of the first exemplary embodiment will be described.

In the fixing device 20 illustrated in FIG. 2, the laser beam Bm emitted from the light source 24 is incident on the nip portion N through the condensing lens 26, the transparent roll 28, and the transparent belt 22. Then, in the nip portion N, the laser beam Bm is absorbed into the toner T on the sheet P. Therefore, the toner image G is pressed by the pressure for acting on the nip portion N while being heated and is fixed onto the sheet P.

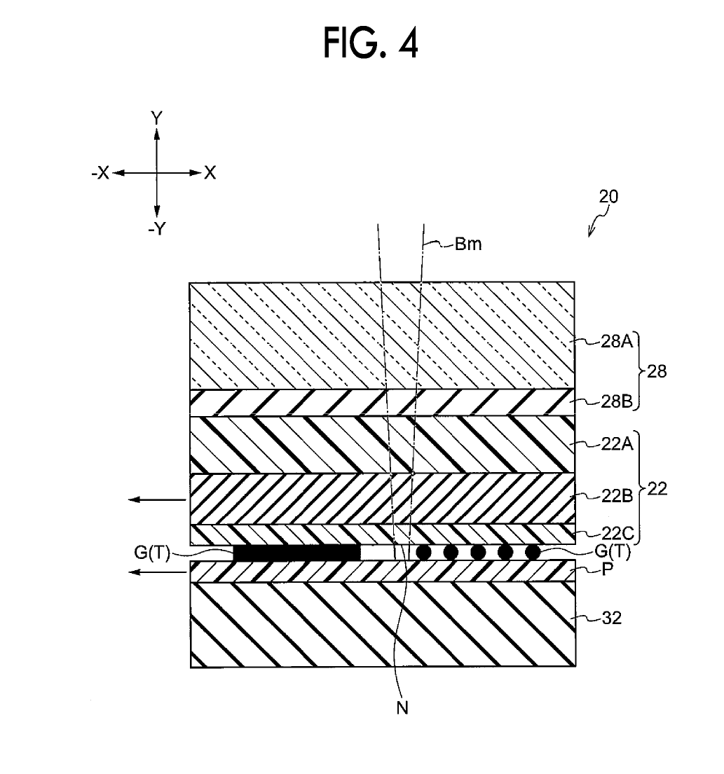

Here, as illustrated in FIG. 4, in the fixing device 20, the elastic layer 28B is formed on the outer circumferential surface of the transparent roll 28. Therefore, in the transparent belt 22 that is circularly moved, even if the base material layer 22A is worn (even if the scratch occurs) by contact with the elastic layer 28B, the elastic layer 28B is elastically deformed (compressed) by the pressurizing force acting on the nip portion N and thereby the elastic layer 28B fills unevenness of the scratch of the base material layer 22A. Therefore, the air layer is unlikely to be formed (air layer is reduced) in an interface between the transparent roll 28 and the transparent belt 22. Moreover, in FIG. 4, the transparent roll 28 is illustrated in the plate shape.

A configuration in which the air layer is unlikely to be formed in the interface between the transparent roll 28 and the transparent belt 22 means that the laser beam Bm transmitted through the base layer 28A and the elastic layer 28B is incident on the base material layer 22A in which a difference in the refractive index with the elastic layer 28B is small. That is, in the fixing device 20, scattering of the laser beam Bm between the transparent roll 28 and the transparent belt 22 is suppressed, as compared to the comparative example described above. In other words, in the fixing device 20, since the condensing performance of the laser beam Bm toward the nip portion N is improved, as compared to the comparative example, a decrease in the light amount of the laser beam Bm applied to the toner image G (toner T) is suppressed.

In addition, in the fixing device 20 illustrated in FIG. 2, since the decrease in the condensing performance of the laser beam Bm toward the toner T is suppressed, a heating temperature of the toner T is suppressed to be lowered lower than a predetermined fixing temperature. Therefore, since a heat amount required to be fixed is applied to the toner T, fixing failure (for example, cold offset) of the toner image G onto the sheet P is suppressed, as compared to the fixing device 200 (see FIG. 6) of the comparative example.

In the image forming apparatus 10 illustrated in FIG. 1, since fixing failure of the toner image G is suppressed in the fixing device 20, as compared to the configuration having the fixing device 200 (see FIG. 6) of the comparative example, image failure (for example, glossiness reduction in the image) by the fixing failure is suppressed.

### Second Exemplary Embodiment

Next, an example of a transparent roll, a light irradiating device, a fixing device, and an image forming apparatus according to a second exemplary embodiment will be described. Moreover, the same reference numerals as the first exemplary embodiment are given to basically the same members and portions as in the first exemplary embodiment described above and the description will be omitted.

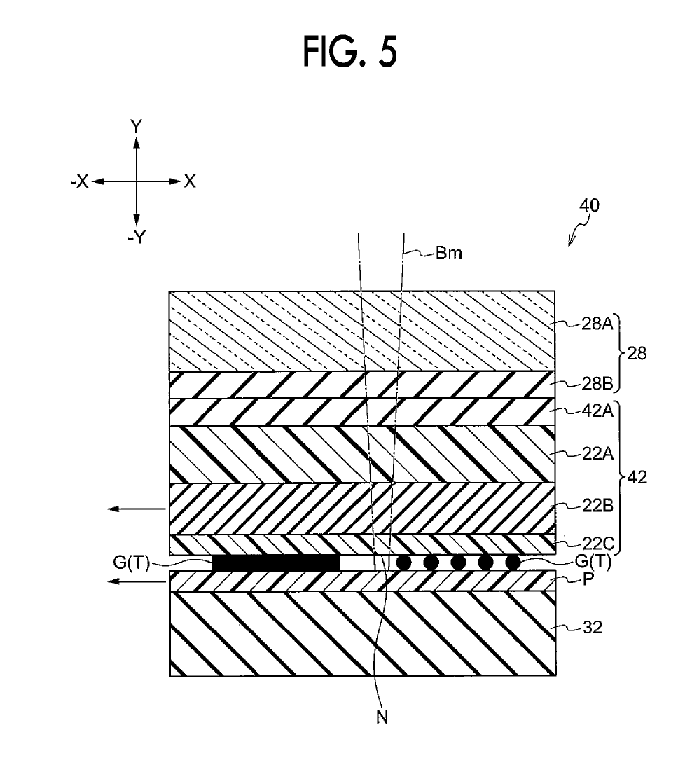

A nip portion N of a fixing device 40 of the second exemplary embodiment is illustrated in FIG. 5. The fixing device 40 has a transparent belt 42, the light source 24, the condensing lens 26 (see FIG. 2), the transparent roll 28, and the pressure roll 32.

Transparent Belt

The transparent belt 42 has a four-layer structure having, as one example, a belt-side elastic layer 42A, the base material layer 22A that is laminated on the belt-side elastic layer 42A, the intermediate layer 22B, and the release layer 22C. Moreover, a primer layer (not illustrated) is formed between the belt-side elastic layer 42A, the base material layer 22A, the intermediate layer 22B, and the release layer 22C to enhance adhesion.

Belt-Side Elastic Layer

The belt-side elastic layer 42A is exposed on the transparent roll 28 side (inside) of the transparent belt 42 with respect to the base material layer 22A. In addition, the belt-side elastic layer 42A is configured with, as one example, silicone rubber and transmits the laser beam Bm. Moreover, the “elastic layer” of the belt-side elastic layer 42A in the exemplary embodiment, is a layer that is elastically deformed in a thickness direction greater than the base material layer 22A when being pressed in the nip portion N. Moreover, a material configuring the belt-side elastic layer 42A may be, for example, LSR silicone rubber, HTV silicone rubber, RTV silicone rubber, and the like.

Moreover, in the exemplary embodiment, “transparent” in the transparent belt 42 means that transparency is sufficiently high in a wavelength range of the laser beam Bm. That is, the transparent belt 42 may transmit the laser beam Bm, and the higher the transparency is, the better the light utilization efficiency is. The transparency may be, as one example, equal to or greater than 90% and may be preferably equal to or greater than 95%.

Operation

Next, an operation of the second exemplary embodiment will be described.

As illustrated in FIG. 5, in the fixing device 40, the elastic layer 28B is formed on an outer circumferential surface of the transparent roll 28 and the belt-side elastic layer 42A is formed on an outer circumferential surface of the transparent belt 42. Therefore, even if the belt-side elastic layer 42A and the elastic layer 28B are worn (even if scratch occurs) by contact between the belt-side elastic layer 42A and the elastic layer 28B, the belt-side elastic layer 42A and the elastic layer 28B are elastically deformed (compressed) by a pressurizing force acting on the nip portion N. Therefore, since unevenness of the contact portion between the belt-side elastic layer 42A and the elastic layer 28B is reduced, an air layer is unlikely to be formed (air layer is reduced) in an interface between the transparent belt 42 and the transparent roll 28, as compared to the comparative example described above.

The configuration in which the air layer is unlikely to be formed in the interface between the transparent roll 28 and the transparent belt 42 means that the laser beam Bm transmitted through the transparent roll 28 is incident on the belt-side elastic layer 42A in which a difference in the refractive index with the transparent roll 28 is small. That is, in the fixing device 40, scattering of the laser beam Bm between the transparent roll 28 and the transparent belt 42 is suppressed, as compared to the comparative example described above. In other words, in the fixing device 40, since the condensing performance of the laser beam Bm toward the nip portion N is improved, as compared to the comparative example, a decrease in the light amount of the laser beam Bm applied to the toner image G (toner T) is suppressed.

In addition, in the fixing device 40, since the decrease in the condensing performance of the laser beam Bm toward the toner T is suppressed, a heating temperature of the toner T is suppressed to be lowered lower than a predetermined fixing temperature. Therefore, since a heat amount required to be fixed is applied to the toner T, fixing failure (for example, cold offset) of the toner image G onto the sheet P is suppressed, as compared to the fixing device 20 (see FIG. 2).

In the image forming apparatus 10 (see FIG. 1) having the fixing device 40, since the fixing failure of the toner image G is suppressed in the fixing device 40, as compared to the configuration having the fixing device 20 (see FIG. 2), image failure (for example, glossiness reduction in the image) by the fixing failure is suppressed.

Moreover, the exemplary embodiments of the invention are not limited to the exemplary embodiments described above.

Examples of the light irradiating device are not limited to the fixing devices 20 and 40 which fix the toner T onto the sheet P. For example, the light irradiating device may be a device that preliminarily heats the toner image by the laser beam Bm before a liquid developer adhered on the sheet P is fixed by a liquid developing method. In addition, the light irradiating device may be a drying device that removes moisture in the sheet P. Furthermore, the light irradiating device may be a bonding device that performs bonding by melting resin by irradiation of the light or may be a curing device that cures a light irradiating target by irradiation of the light.

In a case where a bonding force between the toner T and the intermediate layer 22B is low, the release layer 22C may not be formed in the transparent belt 22. In addition, in a configuration in which the outer circumferential surface of the transparent roll 28 is cleaned by using a soft cleaning blade, oil may be applied on the inner circumferential surface of the transparent belt 22.

According to the configuration in which the laser beam Bm is converged toward the nip portion N, the transparent roll 28 is not limited to be solid and may be hollow. In addition, the transparent roll 28 is not limited to be made of glass and, for example, may be made of resin as arcrylic.

If the elastic layer 28B and the belt-side elastic layer 42A are elastically deformable so that the surfaces have a small air layer, a surface treatment for improving wear resistance may be applied to the surfaces.

The pressure roll 32 is not only made of stainless steel but also made of aluminum or made of other metals. In addition, the elastic layer and the release layer may be provided on the surfaces.

The light source 24 may be provided on an outside of the transparent belt 22.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transparent roll around which a transparent belt that transmits light from a light source is wound and which presses the transparent belt in a nip portion and transmits the light from the light source,
the transparent roll comprising:
a base layer; and
an elastic layer that is exposed on a transparent belt side with respect to the base layer and is elastically deformed greater than the base layer in the nip portion,
wherein the transparent roll has a transparency of equal to or greater than 90%.

2. The transparent roll according to claim 1,
wherein the elastic layer is made of at least one selected from the group consisting of silicone rubber, chloroprene rubber, butyl rubber, acrylic rubber, urethane rubber, nitrile rubber, fluoro rubber, and styrene-butadiene rubber.

3. A light irradiating device comprising:
a light source that irradiates a light irradiating target with light;
a transparent belt that comes into contact with the light irradiating target and transmits the light from the light source;
a transparent roll that comes into contact with the transparent belt at a surface different from a surface at which the transparent belt comes into contact with the light irradiating target, the transparent roll comprising:
a base layer; and
an elastic layer that is exposed on a transparent belt side and is elastically deformed greater than the base layer in a nip portion,
wherein the transparent roll has a transparency of equal to or greater than 90%; and
a pressure member that comes into contact with the light irradiating target at a surface different from a surface at which the transparent belt comes into contact with the transparent roll and presses the light irradiating target toward the transparent roll at a nip portion,
wherein the light from the light source passes through the transparent belt and the transparent roll to be emitted to the light irradiating target.

4. The light irradiating device according to claim 3,
wherein the transparent belt comprises:
a base material layer; and
a belt-side elastic layer that is exposed on a transparent roll side with respect to the base material layer and is elastically deformed greater than the base material layer in the nip portion.

5. The light irradiating device according to claim 3,
wherein the transparent roll converges the light from the light source.

6. An image forming apparatus comprising:
a developer image forming unit that forms a developer image on a recording medium; and
the light irradiating device according to claim 3 that irradiates the developer image, on the recording medium, formed by the developer image forming unit with light.

7. The transparent roll according to claim 1,
wherein the elastic layer is an outermost layer of the transparent roll.

8. The light irradiating device according to claim 3,
wherein the elastic layer is an outermost layer of the transparent roll.

9. The light irradiating device according to claim 3,
wherein the transparent belt has a transparency of equal to or greater than 90%
